(19) United States
(12) Patent Application Publication
(10) Pub. No.: US 2010/0095481 A1
(43) Pub. Date: Apr. 22, 2010

(54) Locking door hinge for outside doors

(76) Inventor: Larry Paul Stefka, Grand Prairie, TX (US)

Correspondence Address: Larry P. Stefka, 842 Blackburn, Grand Prairie, TX, 75050, US

(21) Appl. No.: 12/288,413

(22) Filed: Oct. 21, 2008

(51) Int. Cl. E05D 11/06

(52) U.S. Cl. 16/231

(57) ABSTRACT

A locking hinge for outside doors to help prevent unwanted entry, specifically for anyone wanting additional security. This invention has two or more hardened steel pins going thru hinge pin during manufacture of hinge to prevent door from opening when pins are inserted, while removing pins allows door to open freely.

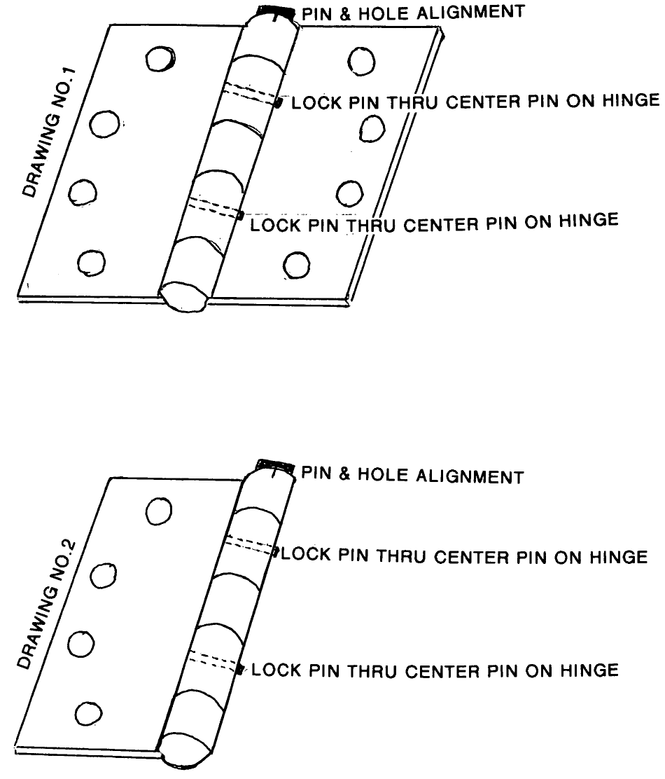

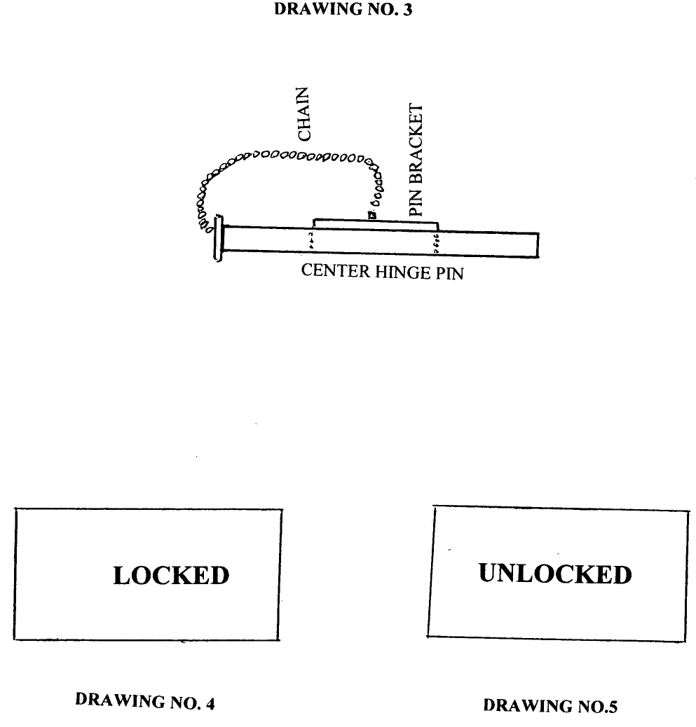

This invention has an alignment guide on the top of the center pin that holds the two parts of the hinge together. Invention has a warning sign above the existing door knob to inform people inside if the door is locked or unlocked.

### CROSS-REFERENCE TO RELATED APPLICATIONS

| | | |
|---|---|---|
| U.S. Pat. No. 4564974 | Jan. 21, 1986 | McGrail |
| U.S. Pat. No. 6591453 | Jul. 15, 2003 | Jenks |

### BACKGROUND OF THE INVENTION

This invention relates to the field of apparatus for a locking door hinge for outside doors to help prevent unwanted entry. Moreover it pertains specifically to anyone want additional security. This invention called locking door hinge has two or more hardened steel pins going thru hinge to help prevent door from opening, while removing pins allows door to open freely. This invention has an alignment guide on the top of the pin that holds the hinge together and has a warning sign above existing door knob to let people inside know door is locked or unlocked.

### BRIEF SUMMARY OF THE INVENTION

This invention relates to the field of apparatus for a locking hinge for outside doors to help prevent unwanted entry, moreover it pertains specifically to anyone wanting additional security. This invention is called locking door hinge has two or more hardened steel pins going thru hinge and hinge pin made during manufacture to prevent door from opening, while removing pins allows door to open freely. This invention has an alignment guide on the top of the center pin that holds the two parts of the hinge together.

This invention has a warning sign above the existing door knob to let people on the inside to know door is locked or unlocked

### SUMMARY OF THE INVENTION

This invention relates to the field of apparatus for a locking door hinge for outside doors to help prevent unwanted entry, moreover it pertains specifically to anyone wanting additional security. This invention called locking door hinge has two or more hardened steel pins going thru hinge and hinge pin during manufacture to prevent door from opening, while removing pins allow door to open freely. This invention has an alignment guide on the top of the center pin that holds the two parts of hinge together. Invention has a warning sign above the existing door knob to inform people inside that the door is locked or unlocked.

### BRIEF DESCRIPTION FOR SEVERAL DRAWINGS

Drawing No. 1. shows a hinge open wide with two locking pins thru center of hinge.

Drawing No. 2. shows a hinge closed with two locking pins thru center of hinge.

Drawing No. 3. shows center hinge pin with pin bracket and chain from top of hinge pin to pin bracket.

Drawing No. 4. shows warning sign, hinge being locked.

Drawing No. 5. shows reverse side of warning sign, unlocked.

### DETAILED DESCRIPTION OF THE INVENTION

This invention relates to the field of apparatus for a locking hinge for outside doors to help prevent unwanted entry.

This invention pertains specifically to anyone wanting additional security above and beyond other locking devices.

This invention has two or more hardened steel pins going thru hinge and hinge pin allowing door to be locked when pins are installed, by removing pins in hinge allows door to open freely.

This invention has an alignment guide on top of center pin that holds the two parts of the hinge together.

This invention has a warning sign above the existing door knob to inform people inside that door is locked or unlocked.

1. This invention relates to a locking hinge for outside doors to prevent unwanted entry, specifically to anyone wanting additional security above and beyond other locking devices.

2. This invention pertains specifically to anyone wanting additional security above and beyond other locking devices.

3. This invention has two or more hardened steel pins going thru hinge and hinge pins allowing door to be locked when pins are installed, and by removing pins, door will open freely. This invention has an alignment guide on top of center pin that holds the two parts of the hinge together.

4. This invention has an alignment guide on top of center pin that holds the two ports of the hinge together.

5. This invention has a warning sign above the existing door knob to inform people inside that the door is locked or unlocked.
